(19) United States
(12) Patent Application Publication
(10) Pub. No.: US 2021/0274292 A1
(43) Pub. Date: Sep. 2, 2021

(54) HEARING DEVICE INCLUDING IMAGE SENSOR

(71) Applicant: Starkey Laboratories, Inc., Eden Prairie, MN (US)

(72) Inventors: Jeffrey P. Solum, Greenwood, MN (US); Tao Zhang, Eden Prairie, MN (US); Dean G. Meyer, Mound, MN (US)

(21) Appl. No.: 16/332,439

(22) PCT Filed: Sep. 15, 2017
(86) PCT No.: PCT/US2017/051712

§ 371 Date: Mar. 12, 2019

Related U.S. Application Data
(60) Provisional application No. 62/395,156, filed on Sep. 15, 2016.

(51) Int. Cl. H04R 25/00; G06T 7/70; G06T 7/521; G06K 9/00; H04N 5/225; H04W 4/029

(52) U.S. Cl. CPC H04R 25/40; G01S 19/13; G06T 7/521; G06K 9/00624; H04N 5/2257; H04R 25/554; H04R 25/65; H04R 25/604; H04R 25/558; H04R 25/603; H04R 25/609; H04R 25/505; H04W 4/029; G06T 2207/10028; H04R 2460/07; H04R 2225/51; H04R 2225/55; H04R 2225/41; G06T 7/70

(57) ABSTRACT

Various embodiments of a hearing device including an image sensor are disclosed. The hearing device can include a housing, a user sensory interface connected to the housing, an image sensor connected to the housing, and an acoustic sensor connected to the housing. The device can also include a processor that is adapted to process image data from the image sensor to identify an image object, process acoustic data from the acoustic sensor, and determine a spatial location of the image object based upon at least one of the processed image data and the processed acoustic data. The processor can also be adapted to provide the spatial location to the user sensory interface, which can provide a sensory stimulus to the user that is representative of the spatial location of the image object.

### CROSS-REFERENCE TO RELATED APPLICATION

This application claims the benefit of U.S. Provisional Application No. 62/395,156, filed Sep. 15, 2016, the disclosure of which is incorporated by reference herein in its entirely.

### BACKGROUND

Navigating in a complex world of obstacles is challenging for individuals that may have one or both of a vision and hearing impairment. It can be desirable for such a person to know the surrounding environment to avoid obstructions and dangerous situations and to improve speech understanding. Various hearing devices such as hearing aids can provide a user that has a hearing impairment acoustic data that is representative of the user's surrounding environment such as sounds from traffic, emergency vehicle sirens, and speech. Identifying physical surroundings and improving speech understanding can, however, be challenging when relying solely upon this acoustic data. For example, while providing some information to the user regarding speech and location, acoustic data does not typically provide a position of one or more objects relative to the user. If the user has a visual impairment, then the acoustic data would not typically help the user navigate around objects or impediments, especially if the objects do not emit sound. Further, speech understanding can be difficult for a hearing-impaired user in certain settings such as a crowded room.

### SUMMARY

In general, the present disclosure provides various embodiments of a hearing device that includes an image sensor and various other devices such as transducers that can be used to provide various sensory stimuli to a user. In one or more embodiments, the hearing device can include the image sensor, an acoustic sensor, and a processor connected to the image sensor and the acoustic sensor. The processor can be adapted to process image data from the image sensor to identify an image object. Further, in one or more embodiments, the processor can also be adapted to process acoustic data from the acoustic sensor. A spatial location of the image object can be determined based upon one or both of the processed image data and the processed acoustic data. Further, the processor can be adapted to provide the spatial location of the image object to a user sensory interface, which in turn can provide a sensory stimulus to the user representative of the spatial location. Further, in one or more embodiments, the hearing device can be utilized to identify a target talker in the presence of the user and improve a signal-to-noise ratio of an audio signal representative of speech of the target talker, and provide such improved audio signal to the user.

In one aspect, the present disclosure provides a hearing device that includes a housing wearable by a user, a user sensory interface connected to the housing, an image sensor connected to the housing, an acoustic sensor connected to the housing, and a processor connected to the housing, the user sensory interface, the image sensor, and the acoustic sensor. The processor is adapted to process image data from the image sensor to identify an image object, process acoustic data from the acoustic sensor, determine a spatial location of the image object based upon the processed image data and the processed acoustic data, and provide the spatial location to the user sensory interface. The user sensory interface is adapted to receive the spatial location from the processor and provide a sensory stimulus to the user representative of the spatial location.

In another aspect, the present disclosure provides a hearing device that includes a housing wearable by a user, a user sensory interface connected to the housing, an image sensor connected to the housing, a haptic transducer connected to the housing, and a processor connected to the housing, the user sensory interface, and the image sensor. The processor is adapted to process image data from the image sensor to identify an image object, determine a spatial location of the image object based upon the processed image data, and provide the spatial location to the user sensory interface. The user sensory interface is adapted to receive the spatial location from the processor and provide a sensory stimulus to the user representative of the spatial location via the haptic transducer.

All headings provided herein are for the convenience of the reader and should not be used to limit the meaning of any text that follows the heading, unless so specified.

The terms “comprises” and variations thereof do not have a limiting meaning where these terms appear in the description and claims. Such terms will be understood to imply the inclusion of a stated step or element or group of steps or elements but not the exclusion of any other step or element or group of steps or elements.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements

As used herein in connection with a measured quantity, the term “about” refers to that variation in the measured quantity as would be expected by the skilled artisan making the measurement and exercising a level of care commensurate with the objective of the measurement and the precision of the measuring equipment used Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

These and other aspects of the present disclosure will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIG. 1 is a schematic perspective view of one embodiment of a hearing device.

FIG. 2 is a schematic cross-section view of the hearing device of FIG. 1 in communication with a mobile phone and internet.

FIG. 3 is a schematic top view of one embodiment of a hearing system that includes first and second hearing devices as worn by a user.

FIG. 4 is a flowchart of one embodiment of a process of providing a spatial location of an image object to a user.

### DETAILED DESCRIPTION

In general, the present disclosure provides various embodiments of a hearing device that includes an image sensor. As used herein, the term “hearing device” can include any suitable hearing device, e.g., conventional hearing aids or other types of hearing devices, including personal sound amplification products (PSAPs) and ear-worn consumer electronic audio devices such as wireless ear buds and head phones.

In one or more embodiments, the hearing device can include a body worn or head worn image sensor, such as a video or still camera, and image processing capable of scene analysis for aiding the visually impaired user in navigating and potentially avoiding at least some collisions, falls, dangerous situations, etc. Using acoustic information available from a processor and receiver worn on a user's ear is one stimulus that could aid in avoiding these situations by informing the user through audio navigation and orientation commands sent to the user's ear. Equipping such a device with an image sensor can facilitate successful navigation by the user. Such a device can also be equipped with wireless communication for off-loading the scene analysis and classification to a device such as a mobile phone (e.g., smartphone) or a cloud computing device connected to the internet.

Modern hearing instruments are now equipped with wireless communication radio such as a Bluetooth radio or Wi-Fi radio, which can provide high-speed data connections with body worn and off body devices having internet connections. Further, cloud computing devices can perform visual classification of objects and complex visual scene analysis.

In one or more embodiments, the hearing device may include a haptic transducer that can also aid a visually impaired and/or a hearing impaired user when navigating the user's environment. For pedestrian movement, which is typically slow enough for frame-by-frame scene analysis, one or both of image data and acoustic data collected by the hearing device can be processed by an onboard remote processor such as an off-body cloud computer to aid in this form of navigation.

Further, the present disclosure describes one or more embodiments of a hearing system that includes first and second hearing devices. In such embodiments, the use of hearing devices in each ear of a user that are equipped with similar image and acoustic sensors, image and acoustic data processing, and wireless communication also can allow for stereoscopic scene analysis, which can further improve classification of objects and distance measurements, thus enhancing the ability of the system to identify not only the objects but their proximity to the user. In one or more embodiments, both image and acoustic data can be processed to enhance the scene analysis and classification of objects.

Certain environments can include simultaneous speech streams from multiple speakers or talkers that can also be contaminated by background noise such as ambient and reverberant noise. It can be desirable to identify and isolate the sounds originating from a target talker and segregate the identified talker's voice from voices of other talkers and background noise. In addition, it can be beneficial to locate where different interfering talkers are in the environment. Location of a particular talker can be challenging when working with acoustic data alone. Adding visual scene analysis to the acoustic scene analysis can improve signal processing of the audio to target the focused speaker and reduce the background noise through acoustic beam forming, targeted directionality, and acoustic null steering. The use of two microphones wired or wirelessly connected can, in one or more embodiments, allow such processing.

One or more hearing devices described herein can improve speech intelligibility based upon optimized signal processing algorithms that can be enabled by visual and/or acoustic scene analysis of a complex environment using, e.g., one or more microphones, image sensors, infrared sensors, etc. In one or more embodiments, visual inputs and/or acoustic inputs can be used to identify an acoustic environment type, e.g., a crowded restaurant, conference room, class room, etc. Further, visual inputs and/or acoustic inputs can be used to identify one or both of the number and identities of the talkers within proximity of the user. The visual inputs may also be used to identify the talker that the user is visually focused on to improve intelligibility of the focused talker's voice.

Various embodiments of hearing devices described herein can provide one or more advantages to users of such devices. For example, a user of one or more embodiments of hearing devices described herein may have one or both of a hearing impairment and a visual impairment. One or more embodiments described herein can provide a spatial location of an object to a visually-impaired user such that the user can locate the object and potentially avoid a collision. Further, one or more embodiments of devices described herein can improve intelligibility and signal-to-noise ratio of an audio signal provided to the user by performing active image scene analysis. Such scene analysis can be done locally or off-loaded using short-range wireless communication with a device capable of analyzing image information or using such device to further off-load the scene analysis to a cloud-connected device using, e.g., internet connectivity such as Microsoft Corporation's Cognitive Services. Further, one or more embodiments described herein can use both image and acoustic inputs to improve intelligibility and signal-to-noise ratio in a hearing device. For example, in one or more embodiments, image and acoustic information can be time stamped and correlated using separate analysis tools. In one or more embodiments, image and acoustic data can be combined and correlated utilizing any suitable processing technology, e.g., IBM Watson, Amazon Web Services, Google Cloud Sendees, Microsoft Azure, etc.

One or more embodiments described herein can also provide augmented hearing instructions for a visually-impaired person using a hearing device that includes a mounted image sensor and wireless connectivity to the internet for scene analysis, where navigational instructions and scene classification can be sent as audio information to the user of the hearing device. Such information can be conveyed to the user to improve his or her mobility in complex situations such as an urban pedestrian environment that the user must navigate. In one or more embodiments, the image information can be processed by the hearing device or a wirelessly-connected device capable of “stand-alone” scene analysis.

Acoustic and image scene analysis can be off-loaded to a cloud computing device or service. Such a service can be provided by various vendors such as IBM, Microsoft, Amazon, or Google. These service providers offer various image and audio analysis capabilities utilizing deep machine learning techniques. Such cognitive cloud-based services may be provided, e.g., by IBM Watson, Microsoft Azure, Amazon Rekognition, Google Cloud Video Intelligence, etc. These services can provide image classification, identification, scene analysis, audio classification, speech recognition, acoustic scene analysis, etc.

In one or more embodiments, visual inputs such as facial characteristics and acoustic inputs can be used to identify the target talker within a complex acoustic environment to allow for optimization of signal processing algorithms. Any suitable technique or techniques can be utilized to identify the target talker, e.g., facial recognition algorithms. In addition to selecting the target talker from other talkers within the scene, other characteristics such as the gender, age, emotion, familiarity with the listener, etc. of the target talker can also be identified. Further, the target talker's lip movements can be used as auxiliary inputs for speech enhancement algorithms.

In one or more embodiments of hearing systems that include first and second hearing devices, the image sensors of both hearing devices may be combined to allow stereoscopic scene analysis. This stereoscopic analysis can be used to compute range, depth, and three-dimensional reconstruction of the visual scene. Combining and correlating image and acoustic data on both devices can be utilized to determine positional information such as the direction and distance of objects and/or nearby obstacles. Acoustic analysis combined with image analysis can be used to determine the reverberance, range, and direction of the audio source. Both the visual and acoustic information can be used by themselves or together to classify objects or identify persons of familiarity to the user. Visual classification of objects can aid in finding the range to such objects if the magnification, field of view of the image sensor, and specifications of such objects such as height, length, and width are known or can be inferred.

In one or more embodiments, GPS position information can also be utilized to determine, e.g., if the user of the hearing device is attempting to cross a street or intersection. In addition, based on visual and/or acoustic data, the hearing device can identify person(s) of familiarity. To augment the identification of persons or objects, speech recognition can be used to associate a person or object with the captured video and or audio. In this case, the user may augment the identification of persons or objects by using speech inputs as training input for various classification algorithms.

Further, one or more embodiments of hearing devices described herein can provide audio descriptions and alerts to the user based upon such positional and geographical information. In one or more embodiments, the hearing device can provide augmented reality and navigation aid information for handicapped and non-handicapped persons including military personnel. For example, stereoscopic scene analysis that one or both of image data and acoustic data can be augmented by positional data provided by GPS navigation devices. Such positional data can be used to determine direction and distance of nearby objects. Based upon positional information, image and acoustic inputs, the hearing device can provide to the user audio descriptions and/or alerts describing persons, animals, vegetation, objects, buildings, etc., proximate the user and/or the user's location. A GPS receiver may be included in the hearing device or may be part of a mobile phone or other body-worn device wirelessly connected to the hearing device.

Any suitable technique or techniques can be utilized with one or more embodiments of hearing devices described herein to provide various image and/or acoustic information. For example, images or video frames and acoustic inputs from the hearing instrument can be digitized, compressed, and uploaded using wireless communication to the cloud or to a smart phone or smart watch. Suitable compressed formats for still images can include .JPG, .PNG, .BMP, .GIF files, etc. Suitable image data compressions can include MPEG-4, MOV, WMV, H.26x, VP6, etc. formats. Further, suitable acoustic compression formats can include MP3, MPEG-4, AAC, PCM, WAV, OPUS, WMA, etc. Using computing on a mobile device and/or on the hearing device, the image and acoustic data can be processed to identify an acoustic scene, identify talkers (including a target talker) and their locations, and determine the locations of objects, obstacles, buildings, doorways, sidewalks, streets, intersections, traffic lights, etc. The extracted information can be put through business logic to determine the proper audio notifications or alerts.

In various embodiments, the captured and digitized visual, and/or audio information may be processed using artificial intelligence techniques for visual understanding (e.g. computer vision based on deep convolutional neural networks) where neural network training is done off-line, e.g., in the cloud, using vast amounts of annotated visual and/or audio data stored in the cloud and w here such weights and parameters for these neural networks may be uploaded on the hearing device or body worn mobile device, having a similar neural network array, where subsequent classifications and recognitions may be performed in real-time either on the hearing device or on a mobile phone wirelessly connected to the hearing device. Selected audio can be sent to the hearing device, and the desired audio alerts, notifications, or haptic stimuli can then be delivered to the user in real time or “near real time” to aid in navigation, warn of approaching danger, or augment the user's reality through a guided tour of the scene, object, or person being viewed by the user. Further, navigation using haptic transducers can be utilized by the user to augment a user's course, speed, navigation, and orientation. The haptic transducer may be part of the hearing device or part of a body worn device. For example, a user could be notified of an obstacle in his or her path to the right by a vibration felt on the user's right side or an obstacle on a user's left side by a vibration on the left. If an obstacle is in front of a user both sides could vibrate indicating to the user to stop movement before altering course.

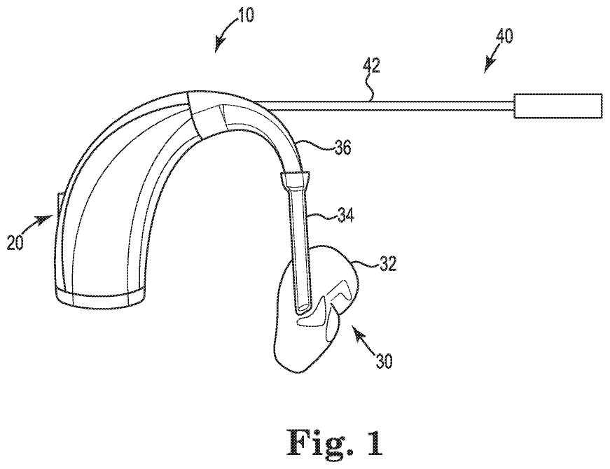

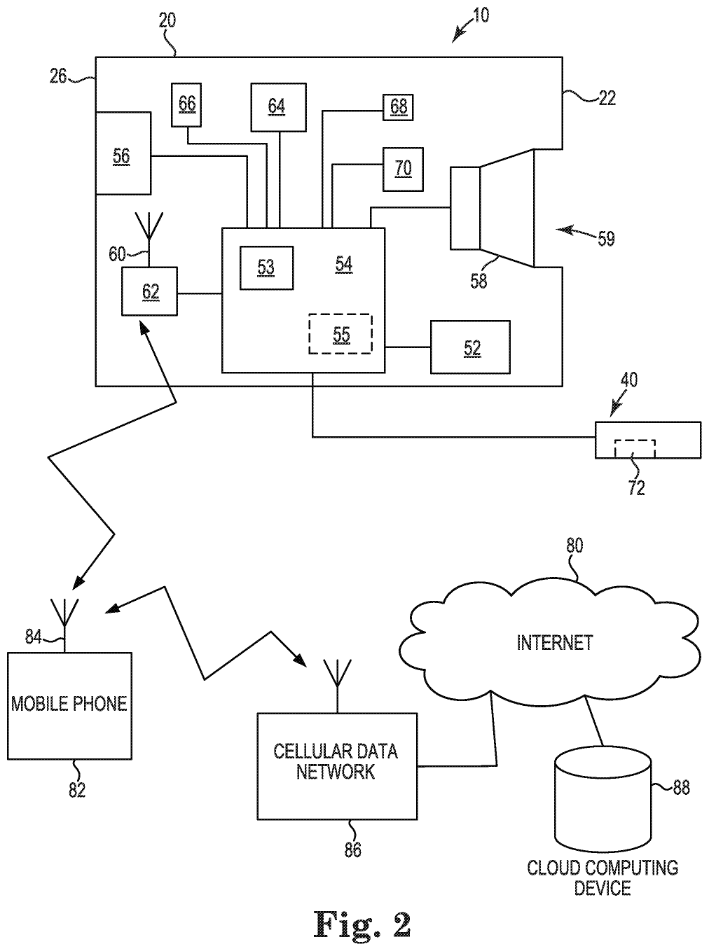

Any suitable hearing device or hearing devices can be utilized to provide the user with one or more sensory stimuli that is representative of various characteristics of the user's environment. For example, FIGS. 1-2 are various views of one embodiment of a hearing device 10. The device 10 can provide sound to an ear of a user (not shown). The device 10 can include any suitable hearing device for a user, including but not limited to, a hearing aid such as behind-the-ear (BTE), in-the-ear (ITE), in-the-canal (ITC), or completely-in-the-canal (CIC) type hearing aid. It is understood that behind-the-ear type hearing aids may include devices that reside substantially behind the ear or over the ear. Such devices may include hearing aids with receivers associated with the electronics portion of the behind-the-ear device, or hearing aids of the type having receivers in the ear canal of the wearer. Such devices are also known as receiver-in-the-canal (RIC) or receiver-in-the-ear (RITE) hearing assistance devices. It is understood that other hearing devices not expressly stated herein may fall within the scope of the present disclosure.

The hearing devices described herein can be utilized in any suitable application. In one or more embodiments, the hearing device can be used with a personal sound amplification product (PSAP), wireless ear buds, or headphones for augmented reality applications using audio augmentation based upon video cues from the image sensor.

The hearing device 10 includes a housing 20 that is wearable by a user on or behind the user's ear and a user sensory interface 30 connected to the housing. The device 10 also includes an image sensor 40 connected to the housing 20, and electronic components 50 disposed within or on the housing.

The housing 20 can take any suitable shape or combination of shapes and have any suitable dimensions. In one or more embodiments, the housing 20 can take a shape that can conform to at least a portion of the ear of the patient. Further, the housing 20 can include any suitable material or materials, e.g., silicone, urethane, acrylates, flexible epoxy, acrylated urethane, and combinations thereof.

Connected to the housing 20 is the user sensory interface 30, which can include any suitable device or devices that provide one or more sensory stimuli to the user as is further described herein. In the embodiment illustrated in FIGS. 1-2, the user sensory interface 30 includes an earmold 32 adapted to be worn in the ear, a sound tube 34 adapted to transmit an acoustic output or sound from the housing 20 to the earmold, and an earhook 36 adapted to connect the housing to the sound tube. As used herein, the term “acoustic output” means a measure of the intensity, pressure, or power generated by the receiver 58.

In one or more embodiments, the user sensory interface 30 can include one or more transducers or sensors connected to the housing or disposed in any suitable location on one or both of a head and body of the user. For example, the user sensory interface 30 can include a haptic transducer 52 disposed in any suitable location such that it can provide a haptic signal to the user as is further described herein. In one or more embodiments, the haptic transducer 52 can be disposed on an inner surface (not shown) of the housing 20 such that the transducer is in contact with the user. Vibrations produced by the haptic transducer can be sensed by the user through the skin.

Also connected to the housing 20 is the image sensor 40, which can include any suitable sensor capable of providing image information or data to the device 10. In one or more embodiments, the image sensor 40 can be a lightweight, lower-power image sensor utilized, e.g., in mobile phones. Such lower-power image sensors can have any suitable value of power consumption for ear worn or body worn electronic devices. In one or more embodiments, the image sensor 40 can have a power consumption value at 1V of no greater than 1 mW. Further, the image sensor 40 can have any suitable dimensions for body worn/head worn electronics. In one or more embodiments, the image sensor 40 can have a footprint of no greater than 2×2×2 mm. In one or more embodiments, the image sensor 40 can include a video image sensor. In one or more embodiments, the image sensor 40 can include a still image sensor.

The image sensor 40 can be connected to the housing 20 of the hearing device 10 in any suitable location on or within the housing of the hearing device using any suitable technique or techniques. For example, in the embodiment illustrated in FIGS. 1-2, the image sensor 40 is connected to the housing 20 of the device 10 by a boom 42 that is connected to an outer surface of the housing. In one or more embodiments that include two or more hearing devices 10, the image sensor 40 of each hearing device may be worn on the body of the user. If the image sensor is “built-in” as part of the hearing device 10 it can to be mounted forward of the ear sufficiently to see forward without a blind spot between the ear worn image sensors of the at least two hearing devices. In one or more embodiments, the image sensor 40 can be mounted away from the head to prevent a blind spot and enhance stereoscopic processing.

Disposed on or within the housing 20 of the device 10 are electronic components 50. The device 10 can include any suitable electronic components 50, e.g., one or more controllers, multiplexers, processors, detectors, radios, wireless antennas, integrated circuits, etc.

For example, FIG. 2 is a schematic cross-section view of the device 10 of FIG. 1 in communication with one or both of a mobile phone 82 and internet 80. Electronic components 50 arc disposed within or on the housing 20 and can include any suitable device or devices, e.g., integrated circuits, power sources, microphones, receivers, etc. For example, in one or more embodiments, the components 50 can include the haptic transducer 52, a processor 54, an acoustic sensor (e.g., microphone) 56, a receiver (e.g., speaker) 58, an antenna 60 connected to a radio 62, and a power source 64. The haptic transducer 52, acoustic sensor 56, receiver 58, antenna 60, radio 62, and power source 64 can be electrically connected to the processor 54 using any suitable technique or techniques.

Any suitable processor 54 can be utilized with the hearing device 10. For example, the processor 54 can be adapted to employ programmable gains to adjust the hearing device's output to a user's particular hearing impairment. The processor 54 can be a digital signal processor (DSP), microprocessor, microcontroller, other digital logic, or combinations thereof. The processing can be done by a single processor, or can be distributed over different devices. The processing of signals referenced in this disclosure can be performed using the processor 54 or over different devices.

In one or more embodiments, the processor 54 is adapted to perform instructions stored in one or more memories 53. Various types of memory can be used, including volatile and nonvolatile forms of memory. In one or more embodiments, the processor 54 or other processing devices execute instructions to perform a number of data processing tasks. Such embodiments can include analog components in communication with the processor 54 to perform data processing tasks, such as sound reception by the acoustic sensor 56, or playing of sound using the receiver 58.

The processor 54 can include any suitable sub-components that can provide various functionalities. For example, in one or more embodiments, the processor 54 can include a neural network 55. The neural network 55 can include any suitable network for analyzing image and acoustic data provided by the image sensor 40 and the acoustic sensor 56.

The electronic components 50 can also include the acoustic sensor 56 that is electrically connected to the processor 54. Although one acoustic sensor 56 is depicted, the components 50 can include any suitable number of acoustic sensors. Further, the acoustic sensor 56 can be disposed in any suitable location on or within the housing 20. For example, in one or more embodiments, a port or opening can be formed in the housing 20, and the acoustic sensor 56 can be disposed adjacent the port to receive acoustic information from the user's environment.

Any suitable acoustic sensor 56 can be utilized, e.g., a microphone. In one or more embodiments, the acoustic sensor 56 can be selected to detect one or more audio signals and convert such signals to an electrical signal that is provided to the processor 54. Although not shown, the processor 54 can include an analog-to-digital convertor that converts the electrical signal from the acoustic sensor 56 to a digital signal.

Electrically connected to the processor 54 is the receiver 58. Any suitable receiver can be utilized. In one or more embodiments, the receiver 58 can be adapted to convert an electrical signal from the processor 54 to an acoustic output or sound that can be transmitted from the housing 20 to the user sensory interface 30 (e.g., earmold 32) and provided to the user. In one or more embodiments, the receiver 58 can be disposed adjacent an opening 59 disposed in a first end 22 of the housing 20. As used herein, the term “adjacent the opening” means that the receiver 58 is disposed closer to the opening 24 disposed in the first end 22 than to a second end 26 of the housing 20.

The components 60 also include the antenna 60 that can be connected to the radio 62. The antenna 60 can be connected to the processor 54 via the radio 62 and can be adapted to transmit image data and acoustic data to a remote processor (e.g. cloud computing device 88) for processing. Any suitable antenna or combination of antennas can be utilized. In one or more embodiments, the antenna 60 can include one or more antennas having any suitable configuration. For example, antenna configurations can vary and can be included within the housing 20 or be external to the housing. Further, the antenna 60 can be compatible with any suitable protocol or combination of protocols, e.g., 900 MHz, Near-field Magnetic Induction (NFMI) protocol, 2.4 GHz protocol, and the like. In one or more embodiments, the radio 62 can also include a transmitter that transmits electromagnetic signals and a radio-frequency receiver that receives electromagnetic signals using any suitable protocol or combination of protocols.

For example, in one or more embodiment, the hearing device 10 can be connected to one or more external devices using, e.g., Bluetooth, Wi-Fi, magnetic induction, etc. For example, in one or more embodiments, the hearing device 10 can be wirelessly connected to internet 80 using any suitable technique or techniques. Such connection can enable the hearing device 10 to access any suitable databases, including medical records databases, cloud computing databases, location services, etc. In one or more embodiments, the hearing device 10 can be wirelessly connected utilizing the Internet of Things (IoT) such that the hearing device can communicate with, e.g., hazard beacons, one or more cameras disposed in proximity to the user, motion sensors, room lights, etc. Further, in one or more embodiments, the hearing device 10 can access weather information via the internet using any suitable technique or techniques such that the user can be informed of potentially hazardous weather conditions.

The powder source 64 is electrically connected to the processor 54 and is adapted to provide electrical energy to the processor and one or more of the other electronic components 50. The power source 64 can include any suitable power source or power sources, e.g., a battery. In one or more embodiments, the power source 64 can include a rechargeable battery, e.g., a Lithium Ion battery. In one or more embodiments, the components 50 can include two or more power sources 64.

Also electrically connected to the processor 54 is the haptic transducer 52. Any suitable transducer or other components can be utilized for the haptic transducer 52 that provides a sensory stimulus to the user that can, e.g., aid the user with navigation and orientation.

As mentioned herein, the electronic components 50 can include any suitable components or devices. For example, in one or more embodiments, the electronic components 50 can include an inertial measurement device (IMU) 66 that can detect movement of the user and provide a signal to the processor 54 that is representative of movement. Any suitable IMU 66 can be utilized, e.g., an accelerometer or gyroscope. Further, the components 50 can also include a magnetometer 68 that can determine an orientation of the user and provide a signal to the processor 54 that is representative of such orientation.

The electronic components 50 can also include the radio 62 that is connected to the antenna. The radio 62 can be adapted to transmit image and acoustic data that has been processed by the processor 54 (e.g., digitized, enhanced, compressed, packetized, e.g.,) prior to transmission and can also be adapted to receive processed packets from a remote processor. Radio 62 is connected to antenna 60, which can send electromagnetic energy to antenna 84 of a body worn or off body mobile device such as a mobile phone 82.

As mentioned herein, the antenna 60 and radio 62 can be utilized to transmit image data and acoustic data to a remote processor for processing. Any suitable processor can be utilized for the remote processor. The remote processor can include a device that is worn or carried by the user. For example, the remote processor can include the mobile phone 82.

The mobile phone 82 can include any suitable mobile phone or smartphone. In one or more embodiments, the mobile phone 82 is adapted to transmit the image data and the acoustic data to a remote network for processing. The remote network can include any suitable device or devices. For example, in one or more embodiments, the remote network can include a cloud computing device 88 that can be connected to the mobile phone 82 by a cellular data network 86 using cellular data or internet 80 utilizing Wi-Fi technology.

A cellular data base station or Wi-Fi gateway associated with the network 86 and internet 80 can receive information wirelessly from the mobile device 82. The cloud computing device 88 can analyze the image and acoustic data from the image sensor 40 and the acoustic sensor 56 for classification and identification. In addition, azimuth, elevation, and relative velocity can be computed for objects within the field of view of the image sensor 40. Such information can be uploaded from the cloud computing device 88 over the various wireless networks to the hearing device 10. One or more sensory stimuli can be provided by the user sensory interface 30 that can, e.g., alert the user of objects in the user's path. Objects may include persons either familiar or unfamiliar to the user. Information from two or more hearing devices 10 can also be uploaded for stereoscopic processing, further enhancing the field and depth of view, and thereby potentially improving accuracy of classification, identification, azimuth, elevation of objects or persons.

In one or more embodiments, neural network processing as described herein may be performed by neural network 55 of the processor 54 of the hearing device 10 or alternately on the mobile device 86 or the cloud computing device 88. Such networks may be loaded with weights and parameters from similar networks found on the cloud computing device 88, where training of such network parameters and weights has been done a-priori using large amounts of training input information such as video frames, pictures, and sounds.

Electronic components 50 of the hearing device 10 can also include a GPS receiver 70 disposed within or on the housing 20 of the device. The GPS receiver 70 is connected to the processor 54 using any suitable technique or techniques. Further, the GPS receiver 70 can be adapted to provide positional data to the processor 54. For example, a GPS location of the user can be provided to the processor 54 and compared to scene information that can be stored in the memory 53 of the processor or accessed through the radio 62 from the cloud computing device 88. In one or more embodiments, the processor 54 can be adapted to process positional data provided by the GPS receiver and provide a geographical location of the user to the user sensory interface 30. The user sensory interface 30 can be adapted to receive the geographical location from the processor 54 and provide a second sensory stimulus to the user that is representative of the geographical location. Although depicted as being disposed within housing 20, the GPS receiver 70 can also be remote from the device 10 and connected to the processor 54 wirelessly through antenna 60 and radio 62. For example, GPS data can be acquired by mobile phone 82 and transmitted to the processor 54 via the antenna 84 of the phone and the antenna 60 disposed within the housing 20.

In one or more embodiments, image data from the image sensor 40 can be used to locate and classify objects. Distances from the user to objects in the user's environment can be determined using any suitable ranging techniques. For example, the image sensor 40 can determine range and azimuth to analyzed objects. Even with a single image, range can be estimated by first classifying an object in the field of view and comparing the dimensions of the object within the field to an average size for the classified object.

In one or more embodiments, the processor 54 of device 10 can be adapted to process the image data from the image sensor 40 and identify an image object by comparing the image data to an image database that can be stored within memory 53 of the processor 54 or on a remote network such as cloud computing device 88. Acoustic data can aid in classifying such objects if the object is emitting sound such as, e.g., a moving car. Once an object is classified e.g., a Chevrolet Malibu automobile, the height, width, and length can be determined from specifications that can be stored within memory 53 of processor 54 or accessed via the radio 62 from the cloud computing device 88. Characteristic sounds of the object, e.g., a unique sound of the engine of the Chevrolet Malibu, can also be utilized to identify the object. Comparing the known specifications of an object to the measured dimensions can help determine a distance between the user and the object using any suitable technique or techniques.

In one or more embodiments, the device 10 can include a range finder 72 that can be utilized to aid in determining a distance from the user to an object in the user's environment. Although depicted as being disposed on or within the image sensor 40, the range finder 72 can be disposed in any suitable location and connected to the processor 54 of the device 10 using any suitable technique or techniques. Any suitable range finder 72 can be utilized, e.g., laser, ultrasonic, infrared, etc. In one or more embodiments, the range finder 72 includes a laser and a receiver adapted to receive at least a portion of electromagnetic radiation emitted by the laser and reflected by the image object, and provide distance data to the processor, where the image data includes the distance data from the range finder.

In one or more embodiments, the device 10 can be utilized to identify a target talker within the environment of the user. Any suitable techniques can be utilized to identify the target talker. For example, in one or more embodiments, image data from the image sensor 40 can be analyzed using any suitable techniques to identify lip movements of one or more persons in the user's environment. For example, image data from the image sensor 40 can be subdivided into subframes until a correlation with lip and mouth movement is recognized within a subframe. Such lip movements can be correlated with acoustic data from the acoustic sensor 56, and signal processing can be utilized to improve a signal-to-noise ratio for the target talker.

Such lip movements can be correlated with acoustic data detected by the acoustic sensor 56 using any suitable technique or techniques, e.g., the neural network 55 of processor 54. The neural network 55 can be trained and used to determine the target talker. In one or more embodiments, the identity of the target talker can further be determined if the target talker is also equipped with a wireless microphone. The input from the target talker's microphone may be amplified with respect to other talkers who may or may not be wearing microphones as well.

Any suitable techniques can be utilized with the hearing device 10 to provide the user with information relating to objects in the user's environment or the environment itself. For example, in one or more embodiments, the processor 54 of device 10 can be adapted to process image data from the image sensor 40 and provide an image scene analysis of the user's surroundings. Any suitable technique or techniques can be utilized by the processor 54 to provide the image scene analysis. Further, the image scene analysis can include any suitable information regarding the user's environment, e.g., the size and type of room occupied by the user, the geographical location of the user, the number of potential speakers present and positions of those speakers relevant to the user, and other information.

Further, the image scene analysis of the user's surroundings can also be utilized to enhance an audio signal provided to the user based upon the image scene analysis. Such audio signal can be provided to the user through the user sensory interface 30. For example, the receiver 58 can direct the audio signal to the user through an earbud or earmold 32 using any suitable technique or techniques.

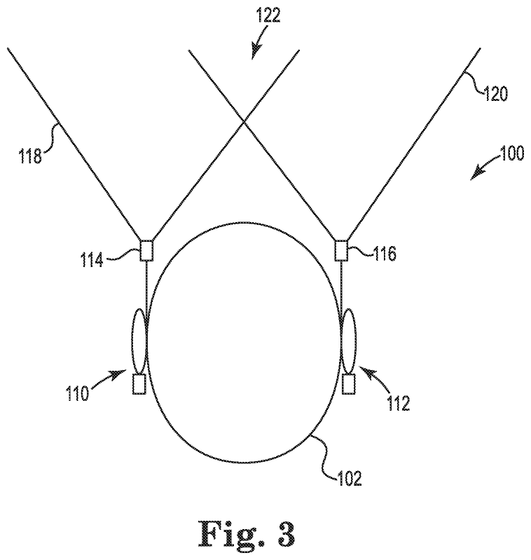

In one or more embodiments, the hearing device 10 described herein can be utilized in a hearing system that can include one or more additional hearing devices. For example, FIG. 3 is a schematic top perspective view of one embodiment of a hearing system 100 as worn by a user 102. The hearing system 100 includes a first hearing device 110 and a second hearing device 112. The first and second hearing devices 110, 112 can be disposed on the user in any suitable location. Further, each of the first and second hearing devices 110, 112 can include any suitable hearing device, e.g., hearing device 10 of FIGS. 1-2. The first hearing device 110 can be the same as the second hearing device 112. In one or more embodiments, the first hearing device 110 can be different from the second hearing device 112. For example, in one or more embodiments, only the first hearing device 110 can include a processor (e.g., processor 54 of device 10), and image and acoustic data detected by the second hearing device 112 can be transmitted to the processor of the first hearing device 110 using any suitable technique or techniques, e.g., near field transmission of data. In one or more embodiments, each of the first and second hearing devices 110, 112 includes an antenna that can be connected to a processor of the device, where the antenna is adapted to transmit image data and acoustic data to a remote processor for processing, e.g., mobile phone 82 and cloud computing device 88 of FIG. 2.

The first hearing device 110 can include an image sensor 114, and the second hearing device 112 can include a second image sensor 116. The first image sensor 114 of the first hearing device 110 can have a first field-of-view 118, and the second image sensor 116 of the second hearing device 112 can have a second field-of-view 120. In one or more embodiments, the image sensors 114, 116 can be positioned such that the first field-of-view 118 overlaps with the second field-of-view 120 to provide stereoscopic region 122. The location (e.g., range) of objects within the stereoscopic region 122 can be determined using any suitable stereoscopic technique, e.g., convergence.

Although not shown, each of the hearing devices 110, 112 can include an acoustic sensor (e.g., acoustic sensor 56 of device 10). Stereosccpic acoustic data can be provided to the user via a user sensory interface (e.g., user sensory interface 30 of device 10) using any suitable technique or techniques. Such stereoscopic acoustic data can be used to measure and angle of arrival of acoustic information to determine the azimuth of an audio source. In addition, visual information travels at the speed of light where acoustic information travels at the speed of sound. Correlating the image data with the acoustic data and measuring the difference in arrival times at the sensors can be used to determine range as well.

Hearing system 100 can be utilized to determine any suitable information and provide the user with one or more sensory stimuli that could be representative of the user's environment, e.g., a spatial location of an object or image object. For example, movement of an object in the user's environment can be determined by acquiring image data at one or more time intervals and comparing such image data to measure displacement of the object. In one or more embodiments, such differential measurements can estimate an object's relative velocity in relation to the user. Further, acoustic data can also be utilized to determine movement of an object. For example, Doppler shift can be measured utilizing acoustic data acquired by one or both of the first and second hearing devices 110, 112.

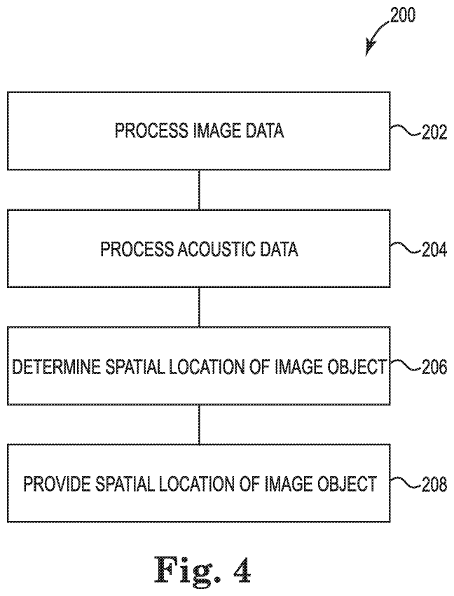

Any suitable technique or techniques can be utilized with the various embodiments of hearing devices described herein to provide one or more sensory stimuli to the user that is representative of the user's environment, e.g., the spatial location of an image object. For example, FIG. 4 is a flowchart of one process 200 that can be utilized by the processor 54 of the hearing device 10 or a remote processor in communication with the device, e.g., mobile phone 82 or cloud computing device 88 of FIG. 2. Although described in reference to hearing device 10 of FIGS. 1-2, the process 200 can be used with any suitable hearing device or hearing system (e.g., hearing system 200 of FIG. 3).

For example, the processor 54 can be adapted to process image data at 202 from the image sensor 40 and identify an image object. Any suitable technique or techniques can be utilized to process image data. At 204, the processor 54 can be adapted to process acoustic data from the acoustic sensor 56, e.g., acoustic information from the image object and the user's environment that is detected by the acoustic sensor. Any suitable technique or techniques can be utilized to process such acoustic data. The processor 54 can further be adapted to determine a spatial location of the image object based upon one or both of the processed image data and the process acoustic data at 206. Any suitable technique or techniques can be utilized to determine the spatial location of the image object. At 208, the processor 54 can be adapted to provide the spatial location to the user sensory interface 30 using any suitable technique or techniques. The user sensory interface 30 can be adapted to receive the spatial location of the image object from the processor 54 and provide a sensory stimulus to the user that is representative of the spatial location of the image object. In one or more embodiments, the sensory stimulus provided by the user sensory interface 30 can include a haptic stimulus or stimuli that can be provided by the haptic transducer 52. Further, in one or more embodiments, the sensory stimulus can include one or more audio signals provided to the user via the speaker 58. For example, such auditory sensory stimuli can include a warning that an object is within a certain distance of the user, a description of the user's scene, a description of the object, and an audio signal representative of an object, etc.

All references and publications cited herein are expressly incorporated herein by reference in their entirety into this disclosure, except to the extent they may directly contradict this disclosure. Illustrative embodiments of this disclosure are discussed and reference has been made to possible variations within the scope of this disclosure. These and other variations and modifications in the disclosure will be apparent to those skilled in the art without departing from the scope of the disclosure, and it should be understood that this disclosure is not limited to the illustrative embodiments set forth herein. Accordingly, the disclosure is to be limited only by the claims provided below.

What is claimed is:

1. A hearing device comprising:
a housing wearable by a user;
a user sensory interface connected to the housing;
an image sensor connected to the housing;
an acoustic sensor connected to the housing; and
a processor connected to the housing, the user sensory interface, the image sensor, and the acoustic sensor, wherein the processor is adapted to:
process image data from the image sensor to identify an image object;
process acoustic data from the acoustic sensor;
determine a spatial location of the image object based upon the processed image data and the processed acoustic data; and
provide the spatial location to the user sensory interface;
wherein the user sensory interface is adapted to receive the spatial location from the processor and provide a sensory stimulus to the user representative of the spatial location.

2. The device of claim 1, further comprising a GPS receiver connected to the processor, wherein the GPS receiver is adapted to provide positional data to the processor.

3. The device of claim 2, wherein the processor is adapted to process the positional data and provide a geographical location to the user sensory interface.

4. The device of claim 3, wherein the user sensory interface is adapted to receive the geographical location from the processor and provide a second sensory stimulus to the user representative of the geographical location.

5. The device of claim 1, further comprising an antenna connected to the processor, wherein the antenna is adapted to transmit the image data and the acoustic data to a remote processor for processing.

6. The device of claim 5, wherein the remote processor comprises a device worn by the user.

7. The device of claim 5, wherein the remote processor comprises a mobile phone.

8. The device of claim 7, wherein the mobile phone is adapted to transmit the image data and the acoustic data to a remote network for processing.

9. The device of claim 8, wherein the remote network comprises a cloud computing device.

10. The device of claim 1, wherein the device further comprises a range finder.

11. The device of claim 10, wherein the range finder comprises a laser and a receiver adapted to receive at least a portion of electromagnetic radiation emitted by the laser and reflected by the image object and provide distance data to the processor, wherein the image data comprises the distance data from the range finder.

12. The device of claim 1, wherein the processor is further adapted to process the image data from the image sensor to identify the image object by comparing the image data to an image database.

13. The device of claim 1, wherein the processor is further adapted to process the image data from the image sensor to provide an image scene analysis of the user's surroundings and enhance an audio signal provided to the user based upon the image scene analysis.

14. The device of claim 1, wherein the spatial location comprises at least one of azimuth, elevation, and relative velocity of the image object relative to the user.

15. A hearing system comprising a first hearing device and a second hearing device, wherein each of the first and second hearing devices comprises the hearing device of claim 1.

16. The system of claim 15, wherein each of the first and second hearing devices comprises an antenna connected to the processor, wherein the antenna of each of the first and second hearing devices is adapted to transmit the image data and the acoustic data to a remote processor for processing.

17. A hearing device comprising:
a housing wearable by a user;
a user sensory interface connected to the housing;
an image sensor connected to the housing;
a haptic transducer connected to the housing; and
a processor connected to the housing, the user sensory interface, and the image sensor, wherein the processor is adapted to:
process image data from the image sensor to identify an image object;
determine a spatial location of the image object based upon the processed image data; and
provide the spatial location to the user sensory interface;
wherein the user sensory interface is adapted to receive the spatial location from the processor and provide a sensory stimulus to the user representative of the spatial location via the haptic transducer.

18. The device of claim 17, further comprising an acoustic sensor connected to the housing and the processor.

19. The device of claim 18, wherein the processor is further adapted to:
process acoustic data from the acoustic sensor; and
determine the spatial location of the image object based upon the processed image data and the processed acoustic data.

20. The device of claim 17, further comprising an antenna connected to the processor, wherein the antenna is adapted to transmit the image data and the acoustic data to a remote processor for processing.
